(19) United States
(12) Patent Application Publication
(10) Pub. No.: US 2025/0192304 A1
(43) Pub. Date: Jun. 12, 2025

(54) STRUCTURAL PLATE MEMBERS FOR ABSORBING AND DISTRIBUTING ENERGY WITHIN TRACTION BATTERY PACKS

(71) Applicant: FORD GLOBAL TECHNOLOGIES, LLC, Dearborn, MI (US)

(72) Inventors: Ali SAAD, Troy, MI (US); Jason C. MARCATH, Dearborn, MI (US); Derek LANGLEY, Dearborn, MI (US); Amar MARPU, Canton, MI (US); Ye Angela CHEN, Northville, MI (US)

(21) Appl. No.: 18/826,266

(22) Filed: Sep. 6, 2024

Related U.S. Application Data
(60) Provisional application No. 63/607,888, filed on Dec. 8, 2023.

(51) Int. Cl. H01M 50/242; B60L 50/64; H01M 50/211; H01M 50/224; H01M 50/262; H01M 50/358

(52) U.S. Cl. CPC H01M 50/242; B60L 50/64; H01M 50/211; H01M 50/224; H01M 50/262; H01M 50/358; H01M 2220/20

(57) ABSTRACT

Structural plate member designs are provided for absorbing and distributing energy within traction battery packs. An exemplary structural plate member may include a wall section having a collapsible feature that is configured to collapse to minimize a transfer of energy in a direction toward a battery internal component of the traction battery pack. The structural plate member may be configured to span a plurality of cell stacks of the traction battery pack and may be secured to one or more cell stacks of the plurality of cell stacks for structurally integrating the traction battery pack.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to structural plate members configured for absorbing and distributing energy within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly providing an interior area, a cell stack arranged within the interior area, and a structural plate member arranged between the cell stack and a side wall of the enclosure assembly. The structural plate member includes a collapsible feature that is configured to collapse to minimize a transfer of energy in a direction toward the cell stack.

In a further non-limiting embodiment of the foregoing traction battery pack, the side wall is part of an enclosure tray of the enclosure assembly.

In a further non-limiting embodiment of either of the foregoing traction battery packs, the structural plate member is mounted to a cross-member assembly of the cell stack.

In a further non-limiting embodiment of any of the foregoing traction battery packs, the structural plate member is mounted to the cross-member assembly by a fastener.

In a further non-limiting embodiment of any of the foregoing traction battery packs, the collapsible feature is part of a wall section of the structural plate member.

In a further non-limiting embodiment of any of the foregoing traction battery packs, the wall section extends between a first outer wall that faces toward the cell stack and a second outer wall that faces toward the side wall of the enclosure assembly.

In a further non-limiting embodiment of any of the foregoing traction battery packs, the second outer wall includes a bulged portion, and the wall section extends between the first outer wall and the bulged portion.

In a further non-limiting embodiment of any of the foregoing traction battery packs, the wall section separates a first vent channel from a second vent channel of the structural plate member.

In a further non-limiting embodiment of any of the foregoing traction battery packs, the collapsible feature includes a notch formed in an internal wall section of the structural plate member.

In a further non-limiting embodiment of any of the foregoing traction battery packs, the notch includes a C-shaped cross-sectional geometry.

In a further non-limiting embodiment of any of the foregoing traction battery packs, the notch includes a S-shaped cross-sectional geometry.

In a further non-limiting embodiment of any of the foregoing traction battery packs, the collapsible feature is an engineered weakened area formed in the structural plate member.

In a further non-limiting embodiment of any of the foregoing traction battery packs, the structural plate member includes a second collapsible feature that is configured to collapse to minimize the transfer of the energy in the direction toward the cell stack. The second collapsible feature is inverted relative to the collapsible feature.

In a further non-limiting embodiment of any of the foregoing traction battery packs, the structural plate member is an extruded metallic component.

In a further non-limiting embodiment of any of the foregoing traction battery packs, a plurality of additional cell stacks are arranged within the interior area. The structural plate member spans the cell stack and the plurality of additional cell stacks.

A traction battery pack according to another exemplary aspect of the present disclosure includes, among other things, an enclosure assembly providing an interior area, a plurality of cell stacks arranged within the interior area, and a structural plate member positioned to span the plurality of cell stacks at a location between the plurality of cell stacks and a side wall of the enclosure assembly. The structural plate member includes a first outer wall, a second outer wall, and a wall section that extends between the first outer wall and the second outer wall. The wall section includes a collapsible feature that is configured to collapse to minimize a transfer of energy in a direction toward the plurality of cell stacks.

In a further non-limiting embodiment of the foregoing traction battery pack, the structural plate member is mounted to a cross-member assembly of a first cell stack of the plurality of cell stacks.

In a further non-limiting embodiment of either of the foregoing traction battery packs, the second outer wall includes a bulged portion, and the wall section extends between the first outer wall and the bulged portion.

In a further non-limiting embodiment of any of the foregoing traction battery packs, the collapsible feature is an engineered weakened area formed in the wall section.

In a further non-limiting embodiment of any of the foregoing traction battery packs, the collapsible feature includes a notch formed in the wall section.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates a structural plate member of the traction battery pack of FIG. 2.

FIG. 4 illustrates another exemplary structural plate member for a traction battery pack.

FIG. 5 illustrates another exemplary structural plate member for a traction battery pack.

FIG. 6 illustrates another exemplary structural plate member for a traction battery pack.

FIG. 7 illustrates yet another exemplary structural plate member for a traction battery pack.

### DETAILED DESCRIPTION

This disclosure relates to structural plate member designs for absorbing and distributing energy within traction battery packs. An exemplary structural plate member may include a wall section having a collapsible feature that is configured to collapse to minimize a transfer of energy in a direction toward a battery internal component of the traction battery pack. The structural plate member may be configured to span a plurality of cell stacks of the traction battery pack and may be secured to one or more cell stacks of the plurality of cell stacks for structurally integrating the traction battery pack. These and other features are discussed in greater detail in the following paragraphs of this detailed description.

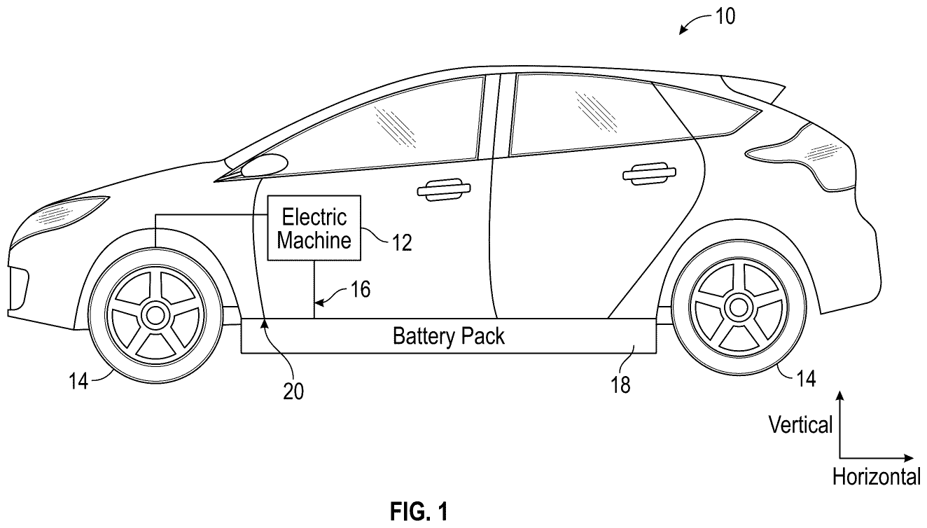

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

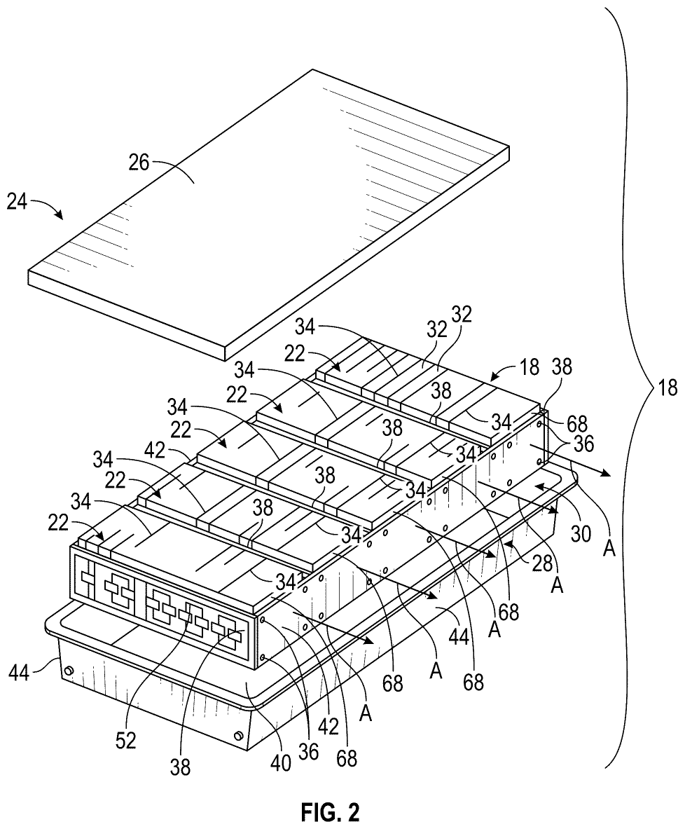

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments of battery cells 32. Each compartment may hold one or more of the battery cells 32 of the cell stack 22.

The battery cells 32 and the thermal barrier assemblies 34 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed on the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The traction battery pack 18 may additionally include a pair of structural plate members 42. One structural plate member 42 may be positioned between ends of the cell stacks 22 and each longitudinally extending side wall 44 of the enclosure tray 28, for example. The structural plate members 42 may extend along axes that are substantially transverse (e.g. perpendicular) to the cell stack axes A of the cell stacks 22 and to the cross-member assemblies 38. The structural plate members 42 can span across a majority of the length of the longitudinally extending side walls 44 of the enclosure tray 28 and are thus sometimes referred to as structural “megabars” of the traction battery pack 18. However, other configurations are contemplated within the scope of this disclosure.

In an embodiment, the cell stacks 22 and the cross-member assemblies 38 extend longitudinally in a cross-vehicle direction of the electrified vehicle 10, and the structural plate members 42 extend longitudinally in a length-wise direction of the electrified vehicle 10. However, other configurations are contemplated within the scope of this disclosure.

The structural plate members 42 may be secured to the cell stacks 22 for further structurally integrating the traction battery pack 18. For example, a plurality of fasteners 36 (e.g., bolts or screws, schematically shown in FIG. 2) may be inserted through the structural plate members 42 and can be accommodated within fastener openings of the cross-member assemblies 38 for securing the structural plate members 42 to the cell stacks 22. These connections can help contain tensile loads that can occur over the life of the cell stacks 22 as a result of battery cell expansion forces, for example.

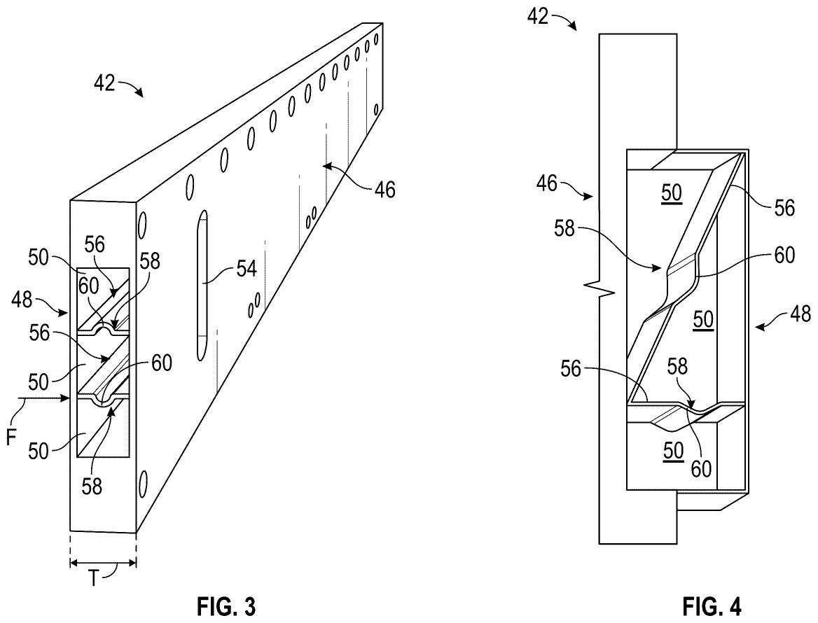

FIG. 3, with continued reference to FIG. 2, illustrates additional details associated with one of the structural plate members 42 of the traction battery pack 18. As would be appreciated by a person of ordinary skill in the art having the benefit of this disclosure, the additional structural plate member 42 of the traction battery pack 18 would include a design that is substantially similar to the structural plate member 42 shown in FIG. 3.

The structural plate member 42 may be an extruded metallic component of the traction battery pack 18. For example, the structural plate member 42 could be an extruded aluminum component. However, other materials and manufacturing techniques could alternatively or additionally be utilized to manufacture the structural plate member 42 within the scope of this disclosure.

The structural plate member 42 may include a first outer wall 46 and a second outer wall 48 that is spaced apart from the first outer wall 46. A thickness T of the structural plate member 42 extends from the first outer wall 46 to the second outer wall 48. When the structural plate member 42 is arranged within the interior area 30 of the enclosure assembly 24, the first outer wall 46 faces toward and can interface with the cell stacks 22, and the second outer wall 48 faces toward and can interface with one of the side walls 44 of the enclosure tray 28.

Two or more vent channels 50 may be formed through the structural plate member 42. The vent channels 50 may extend between the first outer wall 46 and the second outer wall 48 and may extend across an entire length of the structural plate member 42. The vent channels 50 may each be configured to receive and expel vent byproducts from the traction battery pack 18. For example, from time to time, pressure and thermal energy within at least one of the battery cells 32 of the cell stacks 22 can increase. This can lead to the battery cell 32 discharging a flow of the vent byproducts, which can include gas and debris. The vent byproducts can be discharged from the battery cell 32 through a designated cell vent within a housing of the battery cell 32. The cell vent can be a membrane that yields in response to increased pressure and thermal energy within the battery cell 32. The cell vent can also be a ruptured area of the associated battery cell 32.

The cell stacks 22 and their battery cells 32 may be configured to vent through one or more apertures 52 (see FIG. 2) of the cross-member assemblies 38 into one or more an open areas that are adjacent to at least one of the cross-member assemblies 38. From there, the vent byproducts can flow laterally outward toward the structural plate member 42. The vent byproducts may enter the vent channels 50 through one or more inlets 54 of the structural plate member 42, flow longitudinally across the length of the vent channels 50, and then be expelled from the traction battery pack 18 through one or more outlets (not shown) of the structural plate member 42.

Adjacent vent channels 50 may be separated from one another by a well section 56. In the illustrated embodiment, the structural plate member 42 includes three vent channels 50 and two wall sections 56. However, other configurations are contemplated within the scope of this disclosure, and therefore it should be understood that the structural plate member 42 could include any amount of the vent channels 50 and the wall sections 56.

Each wall section 56 may extend inside the structural plate member 42 and is thus an internal component of the structural plate member 42. Each wall section 56 may connect between the first outer wall 46 and the second outer wall 48. In an embodiment, the wall sections 56 of the structural plate member 42 extend in parallel with one another. In another embodiment, at least a portion of the wall sections 56 may extend at a transverse angle relative to other wall sections 56 of the structural plate member 42 (see, e.g., FIG. 4).

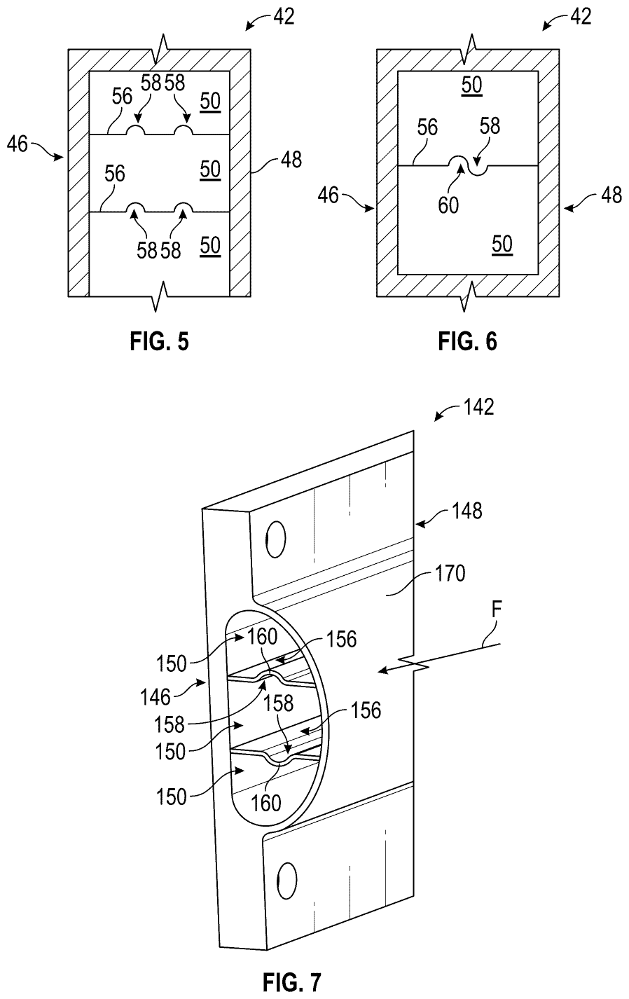

Each wall section 56 may include one or more collapsible features 58 that are designed to absorb and distribute energy within the traction battery pack 18. In an embodiment, each wall section 56 includes a single collapsible feature 58 (see, e.g., FIGS. 3-4). In another embodiment, each wall section 56 includes multiple (e.g., two or more) collapsible features 58 (see, e.g., FIG. 5).

Each collapsible feature 58 may extend across an entire length of the wall section 56 within which it is formed. However, in other implementations, one or more of the collapsible features 58 could be designed to extend across only discrete portions of the length of the wall section 56.

Each collapsible feature 58 may be integrated into its respective wall section 56 by forming a shallow notch 60 into a surface of the wall section 56. In an embodiment, the notch 60 includes a C-shaped cross-sectional geometry (see, e.g., FIGS. 3, 4, and 5). In another embodiment, the notch 60 includes a S-shaped cross-sectional geometry (see, e.g., FIG. 6).

The notch 60 of each collapsible feature 58 provides an engineered weakened area in the wall section 56. The wall section 56 can plastically deform, such as by buckling, crushing, or collapsing, at the collapsible feature 58 when a force F imparted into the second outer wall 48 during a loading event exceeds a predefined load threshold of the collapsible feature 58. The predefined load threshold could be a buckling load threshold, for example. By creating a stress or bending point at the notch 60, energy may be absorbed and distributed across the length of the structural plate member 42, thereby minimizing the intrusion of the loads into the cell stacks 22 where relatively sensitive battery internal components (e.g., the battery cells 32) reside.

The collapsible feature 58 of some of the wall sections 56 of the structural plate member 42 may be inverted relative to the collapsible feature 58 of adjacent wall sections 56 of the structural plate member 42. Providing such an inverted relationship between neighboring collapsible features 58 may substantially reduce the likelihood of the structural plate member 42 rotating during the loading event. The inverted relationship may be accomplished by arranging the collapsible feature of one wall section 56 to include a concave configuration and arranging the collapsible feature of the neighboring wall section 56 to include a convex configuration. Of course, other arrangements of the collapsible features 58 are also contemplated within the scope of this disclosure.

Although various exemplary implementations are described above, the specific arrangement of the wall sections 56 and the geometry and arrangement of the collapsible features 58 may be modified/tuned to optimize the energy absorption and distribution performance of the structural plate member 42.

The structural plate member 42 may embody either a single-piece unitary body or a multi-piece body. For example, in some implementations, the portion of the structural plate member 42 providing the vent channels 50 and the wall sections 56 may be a separate structure that is attached to the portion of the structural plate member 42 providing the first outer wall 46 (see, e.g., the embodiment of FIG. 4).

FIG. 7 illustrates another exemplary structural plate member 142 that could be utilized inside the traction battery pack 18 for absorbing and distributing energy within the traction battery pack 18. The structural plate member 142 may include a first outer wall 146 and a second outer wall 148 that is spaced apart from the first outer wall 146.

The second outer wall 148 may include a bulged portion 170. The bulged portion 170 may protrude in a direction away from the first outer wall 146. When the structural plate member 142 is arranged within the interior area 30 of the enclosure assembly 24, the first outer wall 146 faces toward and can interface with the cell stacks 22, and the second outer wall 148 faces toward and can interface with one of the side walls 44 of the enclosure tray 28.

Two or more vent channels 150 may be formed through the structural plate member 142. The vent channels 150 may extend between the first outer wall 146 and the second outer wall 148 and may extend across an entire length of the structural plate member 42. The vent channels 50 may each be configured to receive and expel vent byproducts from the traction battery pack 18 in the manner described above with respect to FIG. 3.

Adjacent vent channels 150 may be separated from one another by a well section 156. Each wall section 156 may extend inside the structural plate member 142 and can connect between the first outer wall 146 and the bulged portion 170 of the second outer wall 148. The wall sections 156 of the structural plate member 42 may extend in parallel with one another.

Each wall section 156 may include one or more collapsible features 158 that are designed to absorb and distribute energy within the traction battery pack 18. Each collapsible feature 158 may extend across an entire length of the wall section 156 within which it is formed. Each collapsible feature 158 may be integrated into its respective wall section 156 by forming a shallow notch 160 into a surface of the wall section 156.

The notch 160 of each collapsible feature 158 provides an engineered weakened area in the wall section 156. The wall section 156 can plastically deform, such as by buckling, crushing, or collapsing, at the collapsible feature 158 when a force F imparted into the second outer wall 148 during a loading event exceeds a predefined load threshold of the collapsible feature 58. The bulged portion 170 may further facilitate plastic deformation during the loading event by buckling toward the first outer wall 146. By creating a stress or bending point at both the bulged portion 170 and each notch 160, energy may be absorbed and distributed across the length of the structural plate member 142, thereby minimizing the intrusion of the loads into the cell stacks 22 where relatively sensitive battery internal components (e.g., the battery cells 32) reside.

The exemplary structural plate members of this disclosure may include collapsible features designed to absorb and distribute energy during loading events. The structural plate members therefore provide load path management for limiting intrusion of the loads into locations of the traction battery pack that house sensitive components.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly providing an interior area;
a cell stack arranged within the interior area; and
a structural plate member arranged between the cell stack and a side wall of the enclosure assembly,
wherein the structural plate member includes a collapsible feature that is configured to collapse to minimize a transfer of energy in a direction toward the cell stack.

2. The traction battery pack as recited in claim 1, wherein the side wall is part of an enclosure tray of the enclosure assembly.

3. The traction battery pack as recited in claim 1, wherein the structural plate member is mounted to a cross-member assembly of the cell stack.

4. The traction battery pack as recited in claim 3, wherein the structural plate member is mounted to the cross-member assembly by a fastener.

5. The traction battery pack as recited in claim 1, wherein the collapsible feature is part of a wall section of the structural plate member.

6. The traction battery pack as recited in claim 5, wherein the wall section extends between a first outer wall that faces toward the cell stack and a second outer wall that faces toward the side wall of the enclosure assembly.

7. The traction battery pack as recited in claim 6, wherein the second outer wall includes a bulged portion, and the wall section extends between the first outer wall and the bulged portion.

8. The traction battery pack as recited in claim 5, wherein the wall section separates a first vent channel from a second vent channel of the structural plate member.

9. The traction battery pack as recited in claim 1, wherein the collapsible feature includes a notch formed in an internal wall section of the structural plate member.

10. The traction battery pack as recited in claim 9, wherein the notch includes a C-shaped cross-sectional geometry.

11. The traction battery pack as recited in claim 9, wherein the notch includes a S-shaped cross-sectional geometry.

12. The traction battery pack as recited in claim 1, wherein the collapsible feature is an engineered weakened area formed in the structural plate member.

13. The traction battery pack as recited in claim 1, wherein the structural plate member includes a second collapsible feature that is configured to collapse to minimize the transfer of the energy in the direction toward the cell stack, and further wherein the second collapsible feature is inverted relative to the collapsible feature.

14. The traction battery pack as recited in claim 1, wherein the structural plate member is an extruded metallic component.

15. The traction battery pack as recited in claim 1, comprising a plurality of additional cell stacks arranged within the interior area, wherein the structural plate member spans the cell stack and the plurality of additional cell stacks.

16. A traction battery pack, comprising:
an enclosure assembly providing an interior area;
a plurality of cell stacks arranged within the interior area;
a structural plate member positioned to span the plurality of cell stacks at a location between the plurality of cell stacks and a side wall of the enclosure assembly; and
the structural plate member including a first outer wall, a second outer wall, and a wall section that extends between the first outer wall and the second outer wall,
wherein the wall section includes a collapsible feature that is configured to collapse to minimize a transfer of energy in a direction toward the plurality of cell stacks.

17. The traction battery pack as recited in claim 16, wherein the structural plate member is mounted to a cross-member assembly of a first cell stack of the plurality of cell stacks.

18. The traction battery pack as recited in claim 16, wherein the second outer wall includes a bulged portion, and the wall section extends between the first outer wall and the bulged portion.

19. The traction battery pack as recited in claim 16, wherein the collapsible feature is an engineered weakened area formed in the wall section.

20. The traction battery pack as recited in claim 16, wherein the collapsible feature includes a notch formed in the wall section.
